(19) United States
(12) Patent Application Publication
(10) Pub. No.: US 2026/0220883 A1
(43) Pub. Date: Jul. 30, 2026

(54) ADAPTIVE PROGRESSIVE SHADER COMPILATION

(71) Applicant: HUAWEI TECHNOLOGIES CO., LTD., Shenzhen (CN)

(72) Inventors: Yang LIU, Toronto (CA); Guoan SANG, Markham (CA); Danylo VOZOVYKOV, Markham (CA); Mohamed Ibrahim Hafez IBRAHIM, Milton (CA)

(21) Appl. No.: 19/036,535

(22) Filed: Jan. 24, 2025

(51) Int. Cl. G06T 15/80; G06T 1/20

(52) U.S. Cl. CPC G06T 15/80; G06T 1/20

(57) ABSTRACT

The methods, devices, and systems to support adaptive progressive compilation of the shader source code in rendering applications by balancing the CPU compilation and optimization of the code with the GPU execution of the workloads. The frame to frame time delay is mitigated by firstly compiling the provided shader source code and skipping, at least in part, the required optimizations of the compiled shader code to generate the partially optimized compiled shader code in the main thread. The partially optimized compiled shader code is used for rendering the workloads until the optimized compiled shader code becomes available. The optimized compiled shader code is generated in the additional parallel thread.

### CROSS-REFERENCE TO RELATED APPLICATIONS

This is the first application filed for the present invention.

### TECHNICAL FIELD

The present technology generally pertains to methods, devices, and systems for digital code compilation, and, in particular, to methods, devices, and systems to support adaptive progressive compilation of a shader source code in rendering applications.

### BACKGROUND

This innovation is directed to adaptive progressive shader compilation. In the computer graphics rendering or image synthesis is the process of generating a photorealistic or non-photorealistic image from a three dimensional (3D) model by means of a computer program. A shader is a computer program that calculates the appropriate levels of light, darkness, and color during the rendering of a 3D scene. The process is known as shading. Millions of users play games on mobile devices worldwide. Gamers has high demand on game image quality, as well as latency. High image quality together with low latency require significant computational resources for support. However, most of mobile devices have limited resources to run high end games smoothly. An alternative solution to enable more mobile gaming customers, is to use cloud gaming with remote rendering.

The data from professional analytic companies (for example, Gartner and IDC) indicates that the potential market for high end games (GPU server potential market) in China may reach 6.4 B USD in the year of 2025. The severs for cloud phone gaming may account for the significant part of this market with the three billion USD market share and 50% growth rate annually.

For high end gaming application, the frame jitter hurts user experience. Frame to frame jitter may be caused by the shader source code compilation and optimization, as shown in FIG. 1. Frame to frame time fluctuations can make gaming experience unpleasant. Reducing shader compilation times may help ease or completely remove frame to frame time spikes which will lead to smoother gameplay and better user experience, especially in gaming applications limited by the CPU performance.

Therefore, improvements in performance of mobile graphics applications running on cloud servers, and in particular, improvements that overcome frame to frame jitter caused by shader compilations, are desirable.

This background information is provided to reveal information believed by the applicant to be of possible relevance to the present invention. No admission is necessarily intended, nor should be construed, that any of the preceding information constitutes prior art against the present invention.

### SUMMARY

The present disclosure relates to methods, devices, and systems for efficient adaptive progressive compilation of a shader source code in rendering applications. According to embodiments of the present disclosure, there is provided a method for adaptive progressive shader code optimization by a device. The method comprises receiving a sequence of frames, receiving a request to render the sequence of frames by a shader source code, using a count sequence of positive integers to index every frame of the sequence of frames, and providing a frame count number. The frame count number is equal to zero. In some embodiments, the method further comprises: requesting and receiving the shader source code, generating a compiled shader code (CSC), and initiating a discovery operation to discover a bottleneck indication. In response to determining that the discovery operation to discover the bottleneck indication was successful: (1) generating a partially optimized compiled shader code, (2) incrementing the frame count number by one, and (3) selecting a frame from the sequence of frames. An index associated with the frame is equal to the frame count number. According to some embodiments, the method further includes: (4) executing the partially optimized compiled shader code to render the frame, (5) initiating a discovery operation to discover an optimized compiled shader code (OCSC), (6) if the discovery operation to discover the OCSC is successful, executing the OCSC to render each frame of the sequence of frames, a respective index of the each frame is greater than the frame count number, and reporting a completion of rendering the sequence of frames.

According to some embodiments, the method may further include: in response to determining that the discovery operation to discover the bottleneck indication was unsuccessful, (7) generating the OCSC; and (8) executing the OCSC to render the every frame of the sequence of frames. In some embodiments, the method may further include: if said discovery operation to discover the OCSC is unsuccessful, repeating steps (2)-(6).

In some embodiments of the method, the CSC is based at least in part on the shader source code, the partially optimized compiled shader code is based at least in part on the CSC, and the OCSC is based at least in part on the CSC. In some embodiments, the discovery operation to discover the bottleneck indication includes executing a shader complexity analysis function to generate an estimate of a CSC optimization time, an estimate of a CSC execution time, the bottleneck indication, or a combination thereof, and the bottleneck indication being based at least in part on the CSC, a plurality of previous optimization times of the CSC, a plurality of previous execution times of the CSC, or a combination thereof. Furthermore, in some embodiments of the method, the shader complexity analysis function may include a neural network model or a Markov chain model.

In some embodiments, the method further comprises: following said successful discovery of the bottleneck indication, generating the OCSC, and making the OCSC discoverable. In some embodiments of the method, said generating the OCSC is executing a first thread of computing instructions, said generating the partially optimized compiled shader code is executing a second thread of computing instructions, said executing the partially optimized compiled shader code to render the frame is a third thread, and the first thread is independent from the second thread, the third thread, or both. Furthermore, in some embodiments, said executing the first thread of computing instructions being done in parallel to said executing the second thread of computing instructions, or to said executing the third thread of computing instructions, or to both.

According to some embodiments of the present disclosure, there is provided a device to support adaptive progressive shader code optimization. The device is configured to: receive a sequence of frames, receive a request to render the sequence of frames by a shader source code, use a count sequence of positive integers to index every frame of the sequence of frames, provide a frame count number (the frame count number is equal to zero), request and receive the shader source code, generate a compiled shader code (CSC), and initiate a discovery operation to discover a bottleneck indication. In some embodiments, the device is further configured to: in response to determining that the discovery operation to discover the bottleneck indication was successful (1) generate a partially optimized compiled shader code, (2) increment the frame count number by one, (3) select a frame from the sequence of frames (an index associated with the frame is equal to the frame count number), (4) execute the partially optimized compiled shader code to render the frame, (5) initiate a discovery operation to discover an optimized compiled shader code (OCSC), (6) if the discovery operation to discover the OCSC is successful, execute the OCSC to render each frame of the sequence of frames, a respective index of the each frame is greater than the frame count number, and report a completion of rendering the sequence of frames.

In some embodiments, the device further configured to: in response to determining that the discovery operation to discover the bottleneck indication was unsuccessful (7) generate the OCSC, and (8) execute the OCSC to render the every frame of the sequence of frames. The device may be further configured to: if said discovery operation to discover the OCSC is unsuccessful, repeat steps (2)-(6). In some embodiments of the device, the CSC is based at least in part on the shader source code, the partially optimized compiled shader code is based at least in part on the CSC, and the OCSC is based at least in part on the CSC.

In some embodiments of the device, the discovery operation to discover the bottleneck indication includes executing a shader complexity analysis function to generate an estimate of a CSC optimization time, an estimate of a CSC execution time, the bottleneck indication, or a combination thereof, and the bottleneck indication being based at least in part on the CSC, a plurality of previous optimization times of the CSC, a plurality of previous execution times of the CSC, or a combination thereof. In some embodiments of the device, the shader complexity analysis function includes a neural network model or a Markov chain model. According to some embodiments, the device may be further configured to: following said successful discovery of the bottleneck indication, generate the OCSC; and make the OCSC discoverable.

In some embodiments of the device, said generating the OCSC is executing a first thread of computing instructions, said generating the partially optimized compiled shader code is executing a second thread of computing instructions, said executing the partially optimized compiled shader code to render the frame is a third thread, and the first thread is independent from the second thread, the third thread, or both. In some embodiments of the device, said executing the first thread of computing instructions being done in parallel to said executing the second thread of computing instructions, or to said executing the third thread of computing instructions, or to both.

According to some embodiments of the present disclosure, there is provided a communication system. The communication system comprises at least one device to support adaptive progressive shader code optimization. The at least one device is configured to: receive a sequence of frames, receive a request to render the sequence of frames by a shader source code, use a count sequence of positive integers to index every frame of the sequence of frames, provide a frame count number (the frame count number is equal to zero), request and receive the shader source code, generate a compiled shader code (CSC), initiate a discovery operation to discover a bottleneck indication. The at least one device, according to some embodiments, may be further configured to: in response to determining that the discovery operation to discover the bottleneck indication was successful, (1) generate a partially optimized compiled shader code, (2) increment the frame count number by one, (3) select a frame from the sequence of frames, an index associated with the frame is equal to the frame count number, (4) execute the partially optimized compiled shader code to render the frame, (5) initiate a discovery operation to discover an optimized compiled shader code (OCSC), (6) if the discovery operation to discover the OCSC is successful, execute the OCSC to render each frame of the sequence of frames (a respective index of the each frame is greater than the frame count number), and report a completion of rendering the sequence of frames. In some other embodiments of the communication system, the at least one device may be further configured to: in response to determining that the discovery operation to discover the bottleneck indication was unsuccessful (7) generate the OCSC, and (8) execute the OCSC to render the every frame of the sequence of frames.

In accordance with embodiments, a device in a communication network includes a processor, a network interface and a memory and configured to perform one or more of the methods as described herein. In accordance with embodiments, there is provided a communication system of such electronic devices, networked together and configured to interact to perform one or more of the methods as described herein.

In accordance with an embodiment of the present disclosure, there is provided a computer program product including a (e.g., non-transitory or transitory) computer readable medium or a (e.g., non-transitory or transitory) processor readable medium, having statements and instructions stored thereon which, when executed by one or more computer processors, cause the computer processors to perform the method as set forth above. The computer processors may be parts of one or more electronic devices (e.g., network entities) as described herein.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Implementations of the present technology each have at least one of the above-mentioned aspects, but do not necessarily have all of them. It should be understood that some aspects of the present technology that have resulted from attempting to attain the above-mentioned object may not satisfy this object and/or may satisfy other objects not specifically recited herein.

### BRIEF DESCRIPTION OF THE DRAWINGS

Further features and advantages of the present invention will become apparent from the following detailed description, taken in combination with the appended drawings, in which:

FIG. 1 illustrates the performance bottleneck caused by the shader source code compilation and optimization.

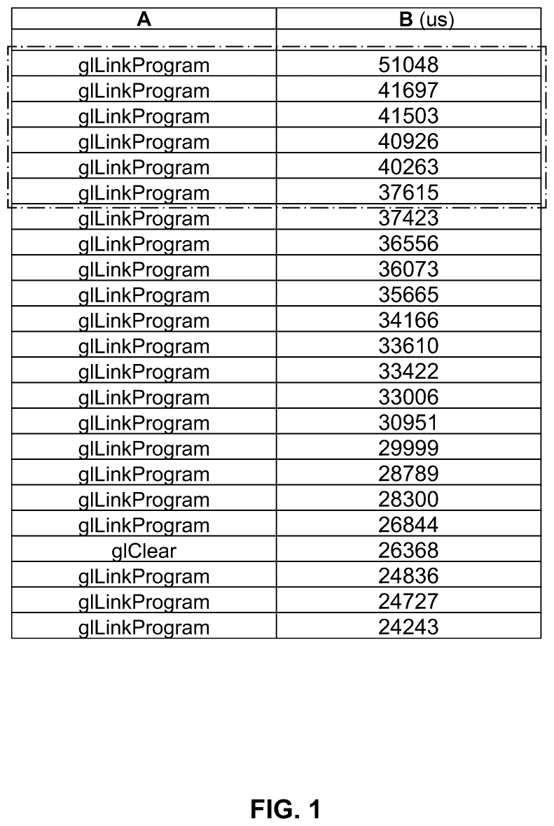

FIG. 2 illustrates the flowchart of the shader source code processing and execution according to some non-limiting embodiments.

FIG. 3 illustrates the flowchart of the progressive shader compilation according to some non-limiting embodiments.

FIG. 4 illustrates the example of the progressive shader compilation pipeline according to some non-limiting embodiments.

FIG. 5 illustrates the time line of frame rendering in accordance with some non-limiting embodiments.

FIG. 6 illustrates the flowchart of the shader source code processing and execution in accordance with some non-limiting embodiments.

FIG. 7 illustrates a device, configured to implement method operations in accordance with embodiments of the present disclosure.

### DETAILED DESCRIPTION

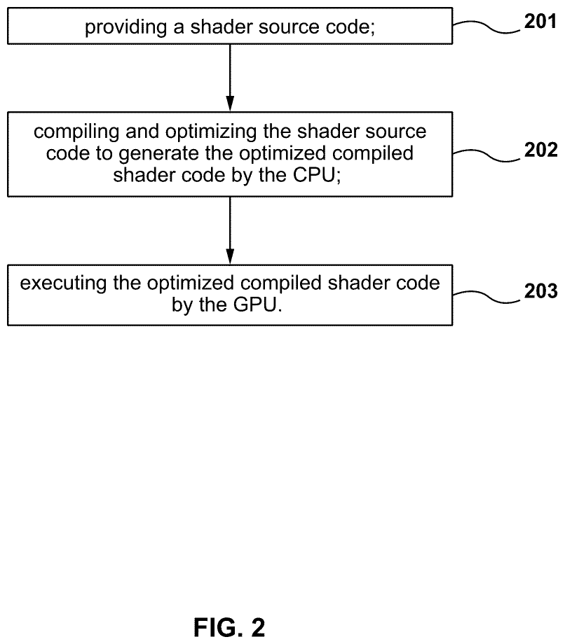

A shader source code, provided at action 201, may be compiled by a central processing unite (CPU) of an electronic device at action 202, and executed by a graphics processing unite (GPU) at action 203 as shown in FIG. 2. Therefore, the rendering time may consist of the CPU compilation time and the GPU execution time.

There are two state-of-the-art solutions to improve performance of the shader. The first solution is directed to shader compilation optimization. To further improve shader compilation to speed up GPU shader execution more CPU calculations (optimization cycles) may be employed. However, it may lead to CPU performance issues, making frame to frame jitter worse: burning more CPU cycles for compilation optimization may result in higher frame rendering time. The other state of the art solution involves a shader cache. After a first-time compilation, the system may store previously compiled shader binary code in the system to retrieve the stored binary code directly without repeating compilation if a next frame requires the same shader. However, caching the compiled shader binary code will not improve the frame rendering time for the first frame. Furthermore, storing the compiled shader binary code in the shader cache may not be helpful when the shader source code is dynamically updated, as that requires shader compilation for each updated shader.

The instant disclosure is directed to achieving reduction in compilation by skipping optimizations of the compiled shader code. This may result in faster compilation but it may also produce an unoptimized compiled shader binary code for the GPU to execute. Because of that, skipped optimization of the compiled shader code needs to be balanced with the GPU shader execution time in order to achieve improved frame rendering times. To avoid lower frame per second (FPS) rates caused by unoptimized compiled shader binary code, fully optimized compiled shader binary code are required. Unoptimized compiled shader binary code may be fully optimized in a separate thread, and then optimized compiled shader binary code may replace unoptimized code and be used to render consecutive frames. Applications running on a server or a client device, especially applications with low latency requirement, including platforms that support 3D applications such as virtual exhibitions, gaming, virtual meetings, etc., may benefit from the disclosed technology.

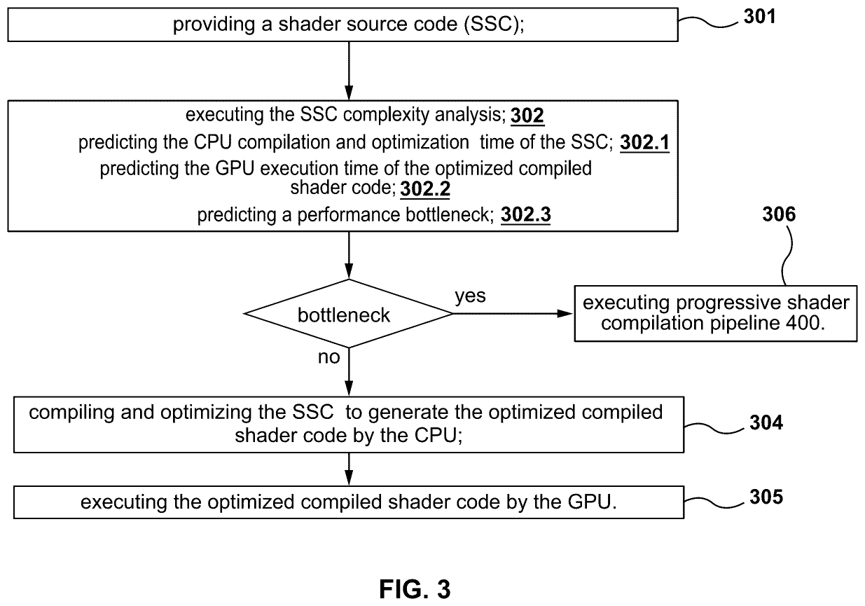

FIG. 3 illustrates the overall structure of progressive shader compilation executed by the electronic device. At action 301, providing the shader source code (SSC), wherein the SSC is provided to render a sequence of frames. At action 302, executing the SSC complexity analysis, which may lead to predicting the CPU compilation and optimization time (302.1), predicting the GPU execution time of the optimized compiled shader code (302.2), and predicting a performance bottleneck (302.3). In some embodiments a Shader Complexity Analysis function may be used to evaluate the SSC. The Shader Complexity Analysis function takes the SSC as input and predicts its CPU compilation and optimization time and GPU execution time, based on the history data and their correlations. The Shader Complexity Analysis function may predict if the provided shader source code compilation causes the end-to-end performance bottleneck. In some embodiments this prediction may be based on the history data of the provided SSC, including the shader code complexity, previous compilation time, and previous execution time. In some embodiments the Shader Complexity Analysis function may based on a neural network model or a Markov chain model.

At action 304, if there was no prediction of the performance bottleneck, compiling and optimizing the SSC to generate the optimized compiled shader code by the CPU. At action 305, executing by the GPU the optimized compiled shader code.

If, at action 302, the end-to-end performance bottleneck, caused by optimization of the compiled shader binary code, is predicted, Progressive Shader Compilation pipeline 400 may be engaged. Progressive Shader Compilation pipeline 400 is executed at action 306. Progressive Shader Compilation pipeline 400 may help to save CPU compilation time by skipping some optimizations of the compiled shader code. This may result in faster CPU compilation. This may also slow down GPU execution as the GPU will execute the unoptimized compiled shader binary code. However, if the CPU compilation time for the provided shader source code is more significant than the GPU execution time, overall frame rendering performance may improved.

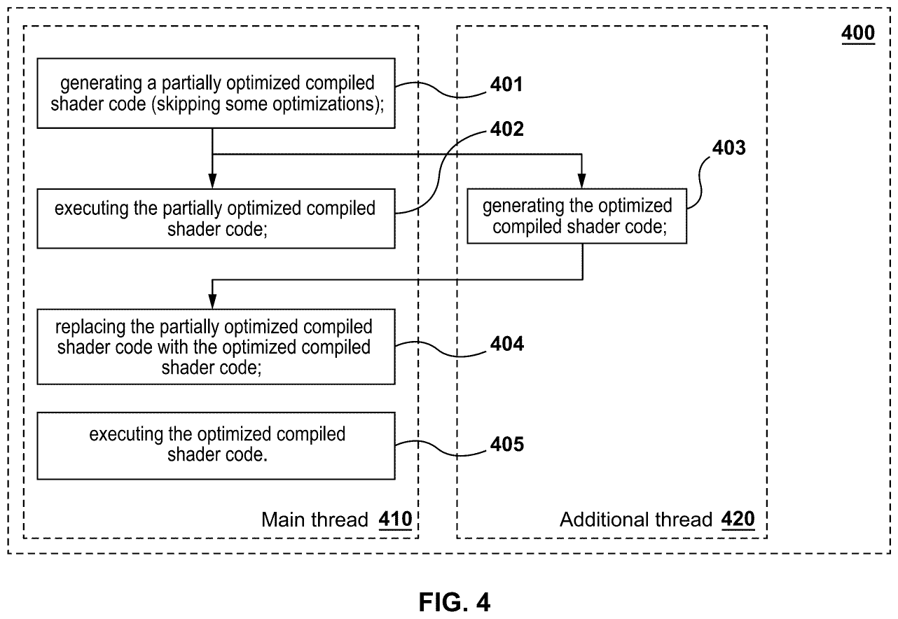

FIG. 4 illustrates an example of progressive shader compilation pipeline 400 according to some non-limiting embodiments. Progressive shader compilation pipeline 400 may include main thread 410 and additional thread 420. At action 401 of main thread 410, generating a partially optimized compiled shader code. At action 402, executing the partially optimized compiled shader code. At action 403 of additional thread 420, generating the optimized compiled shader code. At action 404, following the discovery of the optimized compiled shader code, replacing the partially optimized compiled shader code with the optimized compiled shader code, and, at action 405, executing the optimized compiled shader code.

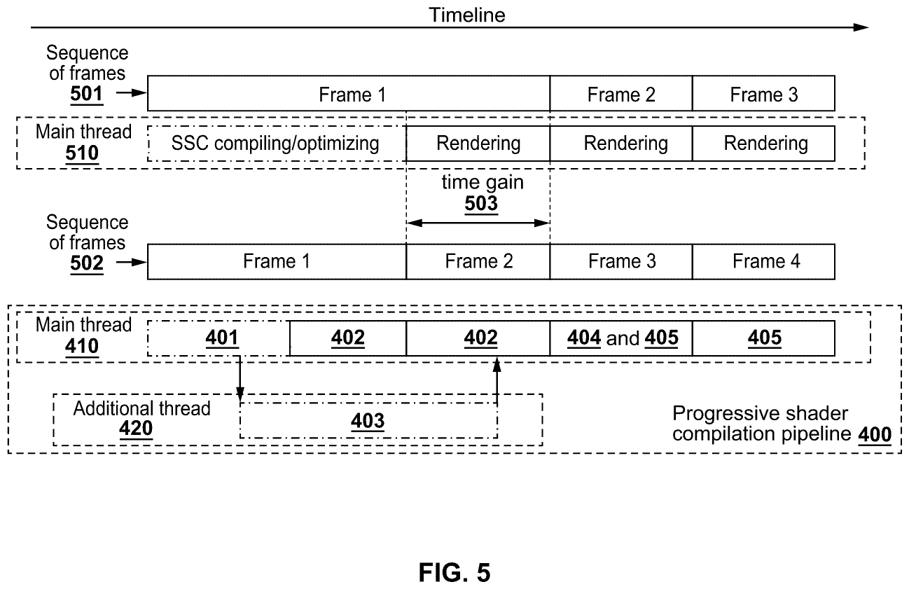

The rendering system may provide adaptive progressive shader compilation to achieve the best system performance by balancing the CPU compilation and optimization, and the GPU execution of workloads. A frame time spike is caused by optimization of the compiled shader binary code. The frame time spike may be mitigated by firstly compiling the provided shader source code and skipping (at least in part) the required optimizations, and, secondly, starting compilation of the compiled shader binary code in the parallel thread. FIG. 5 illustrates the time line of frame rendering by the electronic device in accordance with some non-limiting embodiments. The SSC is compiled, optimized, and then used for rendering sequence of frames 501 in main thread 510. Progressive shader compilation pipeline 400 is used to render sequence of frames 502. Sequence of frames 502 is rendered in main thread 410, while generation of the optimized compiled shader code 403 is accomplished in additional thread 420. Application of progressive shader compilation pipeline 400 for rendering sequence of frames 502 provides for time gain 503 as shown in FIG. 5.

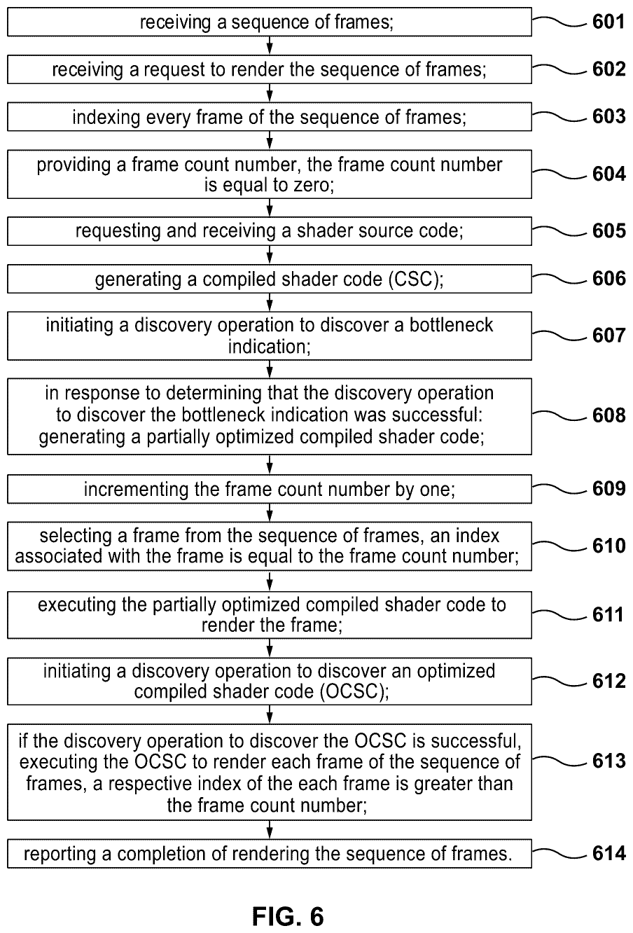

FIG. 6 illustrates the flowchart of the shader source code processing and execution by the electronic device in accordance with some non-limiting embodiments. At action 601, receiving a sequence of frames. At action 602, receiving a request to render the sequence of frames by a shader source code. At action 603, using a count sequence of positive integers to index every frame of the sequence of frames. At action 604, providing a frame count number, the frame count number is equal to zero. At action 605, requesting and receiving the shader source code. At action 606, generating a compiled shader code (CSC).

At action 607, initiating a discovery operation to discover a bottleneck indication. At action 608, in response to determining that the discovery operation to discover the bottleneck indication was successful: generating a partially optimized compiled shader code. At action 609, incrementing the frame count number by one. At action 610, selecting a frame from the sequence of frames. An index associated with the frame is equal to the frame count number. At action 611, executing the partially optimized compiled shader code to render the frame. At action 612, initiating a discovery operation to discover an optimized compiled shader code (OCSC). At action 613, if the discovery operation to discover the OCSC is successful, executing the OCSC to render each frame of the sequence of frames, a respective index of the each frame is greater than the frame count number. At action 614, reporting a completion of rendering the sequence of frames.

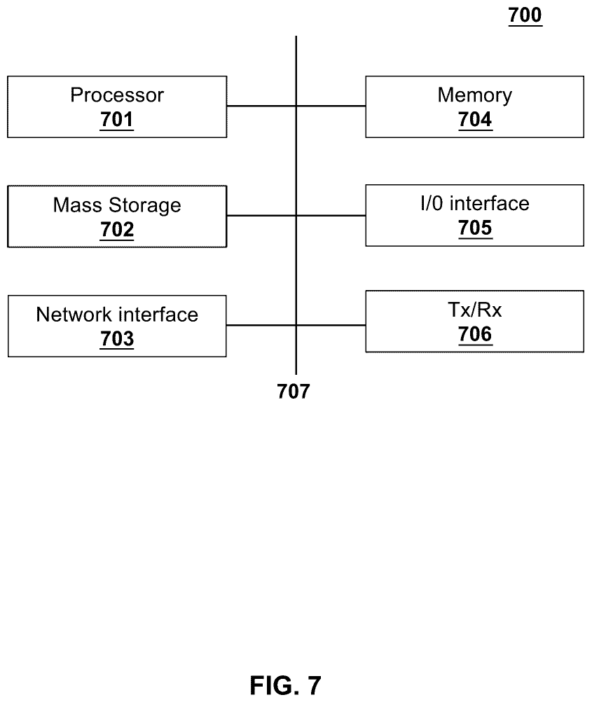

FIG. 7 illustrates a block diagram of device 700 configured to executed the method operations of the present disclosure. Device 700 may wirelessly communicate with one or more other devices of a communication system. Device 700 may comprise a computer processor operatively coupled to a computer memory. A computer equipped with network function including wireless transceiver may be configured as device 700. Device 700 may correspond to parts of a computer server, or a network node providing network access (e.g., an IEEE 802.11 access point (AP) or similar device), or a network node accessing a network, e.g., an IEEE 802.11 wireless station (STA). Device 700 may be wirelessly coupled to other devices via a wireless local area network (WLAN) such as an IEEE 802.11 compliant WLAN.

As shown in FIG. 7, device 700 includes a processor 701, such as a Central Processing Unit (CPU) or specialized processors such as a Graphics Processing Unit (GPU) or other such processor unit, memory 704, non-transitory mass storage 702, I/O interface 705, network interface 703, and wireless transceiver 706, all of which are communicatively coupled via bi-directional bus 707. Transceiver 706 includes one or multiple antennas. According to certain embodiments, any or all of the depicted elements may be utilized, or only a subset of the elements. Further, device 700 may contain multiple instances of certain elements, such as multiple processors, memories, or transceivers. Also, elements of the hardware device may be directly coupled to other elements without the bi-directional bus. Additionally or alternatively to a processor and a memory, other processing electronics, such as application specific integrated circuits, field programmable gate arrays, digital circuitry, analog circuitry, or the like, or a combination thereof may be employed for performing the required logical operations. Each integrated circuit may include one or more of semiconductor chips, and semiconductor chiplets.

Memory 704 may include any type of non-transitory memory such as static random access memory (SRAM), dynamic random access memory (DRAM), synchronous DRAM (SDRAM), read-only memory (ROM), any combination of such, or the like. Mass storage element 702 may include any type of non-transitory storage device, such as a solid state drive, hard disk drive, a magnetic disk drive, an optical disk drive, USB drive, or any computer program product configured to store data and machine executable program code. According to certain embodiments, memory 704 or mass storage 702 may have recorded thereon statements and instructions executable by the processor 701 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Furthermore, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Modifications and improvements to the above-described implementations of the present technology may become apparent to the person skilled in the art. The foregoing description is intended to be exemplary rather than limiting.

What is claimed is:

1. A method for adaptive progressive shader code optimization, by a device, the method comprising:
receiving a sequence of frames;
receiving a request to render the sequence of frames by a shader source code;
using a count sequence of positive integers to index every frame of the sequence of frames;
providing a frame count number, the frame count number is equal to zero;
requesting and receiving the shader source code;
generating a compiled shader code (CSC);
initiating a discovery operation to discover a bottleneck indication;
in response to determining that the discovery operation to discover the bottleneck indication was successful:
(1) generating a partially optimized compiled shader code;
(2) incrementing the frame count number by one;
(3) selecting a frame from the sequence of frames, an index associated with the frame is equal to the frame count number;
(4) executing the partially optimized compiled shader code to render the frame;
(5) initiating a discovery operation to discover an optimized compiled shader code (OCSC);
(6) if the discovery operation to discover the OCSC is successful, executing the OCSC to render each frame of the sequence of frames, a respective index of the each frame is greater than the frame count number; and
reporting a completion of rendering the sequence of frames.

2. The method of claim 1 further including:
in response to determining that the discovery operation to discover the bottleneck indication was unsuccessful:
(7) generating the OCSC; and
(8) executing the OCSC to render the every frame of the sequence of frames.

3. The method of claim 1 further including:
if said discovery operation to discover the OCSC is unsuccessful, repeating steps (2)-(6) of claim 1.

4. The method of claim 1,
wherein the CSC is based at least in part on the shader source code,
wherein the partially optimized compiled shader code is based at least in part on the CSC, and
wherein the OCSC is based at least in part on the CSC.

5. The method of claim 1,
wherein the discovery operation to discover the bottleneck indication includes executing a shader complexity analysis function to generate an estimate of a CSC optimization time, an estimate of a CSC execution time, the bottleneck indication, or a combination thereof, and
wherein the bottleneck indication being based at least in part on the CSC, a plurality of previous optimization times of the CSC, a plurality of previous execution times of the CSC, or a combination thereof.

6. The method of claim 5, wherein the shader complexity analysis function includes a neural network model or a Markov chain model.

7. The method of claim 1, further comprising:
following said successful discovery of the bottleneck indication, generating the OCSC; and
making the OCSC discoverable.

8. The method of claim 7,
wherein said generating the OCSC is executing a first thread of computing instructions,
wherein said generating the partially optimized compiled shader code is executing a second thread of computing instructions,
wherein said executing the partially optimized compiled shader code to render the frame is a third thread, and
wherein the first thread is independent from the second thread, the third thread, or both.

9. The method of claim 8, wherein said executing the first thread of computing instructions being done in parallel to said executing the second thread of computing instructions, or to said executing the third thread of computing instructions, or to both.

10. A device to support adaptive progressive shader code optimization, the device configured to:
receive a sequence of frames;
receive a request to render the sequence of frames by a shader source code;
use a count sequence of positive integers to index every frame of the sequence of frames;
provide a frame count number, the frame count number is equal to zero;
request and receive the shader source code;
generate a compiled shader code (CSC);
initiate a discovery operation to discover a bottleneck indication;
in response to determining that the discovery operation to discover the bottleneck indication was successful:
(1) generate a partially optimized compiled shader code;
(2) increment the frame count number by one;
(3) select a frame from the sequence of frames, an index associated with the frame is equal to the frame count number;
(4) execute the partially optimized compiled shader code to render the frame;
(5) initiate a discovery operation to discover an optimized compiled shader code (OCSC);
(6) if the discovery operation to discover the OCSC is successful, execute the OCSC to render each frame of the sequence of frames, a respective index of the each frame is greater than the frame count number; and
report a completion of rendering the sequence of frames.

11. The device of claim 10 further configured to:
in response to determining that the discovery operation to discover the bottleneck indication was unsuccessful:
(7) generate the OCSC; and
(8) execute the OCSC to render the every frame of the sequence of frames.

12. The device of claim 10 further configured to:
if said discovery operation to discover the OCSC is unsuccessful, repeat steps (2)-(6) of claim 1.

13. The device of claim 10,
wherein the CSC is based at least in part on the shader source code,
wherein the partially optimized compiled shader code is based at least in part on the CSC, and
wherein the OCSC is based at least in part on the CSC.

14. The device of claim 10,
wherein the discovery operation to discover the bottleneck indication includes executing a shader complexity analysis function to generate an estimate of a CSC optimization time, an estimate of a CSC execution time, the bottleneck indication, or a combination thereof, and
wherein the bottleneck indication being based at least in part on the CSC, a plurality of previous optimization times of the CSC, a plurality of previous execution times of the CSC, or a combination thereof.

15. The device of claim 14, wherein the shader complexity analysis function includes a neural network model or a Markov chain model.

16. The device of claim 10, further configured to:
following said successful discovery of the bottleneck indication, generate the OCSC; and
make the OCSC discoverable.

17. The device of claim 16,
wherein said generating the OCSC is executing a first thread of computing instructions,
wherein said generating the partially optimized compiled shader code is executing a second thread of computing instructions,
wherein said executing the partially optimized compiled shader code to render the frame is a third thread, and
wherein the first thread is independent from the second thread, the third thread, or both.

18. The device of claim 17, wherein said executing the first thread of computing instructions being done in parallel to said executing the second thread of computing instructions, or to said executing the third thread of computing instructions, or to both.

19. A non-transitory processor readable medium storing processor executable instructions, the processor executable instructions, when executed by a processor of a device, cause the device to:
receive a sequence of frames;
receive a request to render the sequence of frames by a shader source code;
use a count sequence of positive integers to index every frame of the sequence of frames;
provide a frame count number, the frame count number is equal to zero;
request and receive the shader source code;
generate a compiled shader code (CSC);
initiate a discovery operation to discover a bottleneck indication;
in response to determining that the discovery operation to discover the bottleneck indication was successful:
(1) generate a partially optimized compiled shader code;
(2) increment the frame count number by one;
(3) select a frame from the sequence of frames, an index associated with the frame is equal to the frame count number;
(4) execute the partially optimized compiled shader code to render the frame;
(5) initiate a discovery operation to discover an optimized compiled shader code (OCSC);
(6) if the discovery operation to discover the OCSC is successful, execute the OCSC to render each frame of the sequence of frames, a respective index of the each frame is greater than the frame count number; and
report a completion of rendering the sequence of frames.

20. The non-transitory processor readable medium of claim 19, wherein the processor executable instructions, when executed by the processor of the device, further cause the device to:
in response to determining that the discovery operation to discover the bottleneck indication was unsuccessful:
(7) generate the OCSC; and
(8) execute the OCSC to render the every frame of the sequence of frames.
